(19) United States
(12) Patent Application Publication
(10) Pub. No.: US 2012/0175221 A1
(43) Pub. Date: Jul. 12, 2012

(54) High Speed Diverter

(75) Inventors: Stephen C. Wolf, New Fairfield, CT (US); Jose Antonio Gomez, Sherman, CT (US); Gary P. Freudenberg, Lake Forest, CA (US); Csaba Tilger, Dover Plains, NY (US); Piotr Dobkowski, Danbury, CT (US)

(73) Assignee: DAIRY CONVEYOR CORP, Brewster, NY (US)

(21) Appl. No.: 13/344,300

(22) Filed: Jan. 5, 2012

Related U.S. Application Data
(60) Provisional application No. 61/430,772, filed on Jan. 7, 2011.

(51) Int. Cl. B65G 47/34

(52) U.S. Cl. 198/348

(57) ABSTRACT

An apparatus for selectively diverting same size articles including a conveying apparatus, a pusher device positioned proximal the conveying apparatus, at least one divergent pathway disposed transverse to the conveying apparatus and substantially opposite the pusher device, and at least one sensor positioned proximal the pusher device, wherein the sensor is operable to detect the presence or absence of an article on the conveyor apparatus and actuate the pusher device to selectively push the article to the divergent pathway. A velocity control device operates to control the flow of articles along the conveying device.

### CROSS REFERENCE TO RELATED APPLICATIONS

This application claims the benefit of U.S. Provisional Patent Application No. 61/430,772, filed Jan. 7, 2011, the entirety of which is incorporated herein by reference.

### FIELD OF THE INVENTION

The presently disclosed subject matter is directed to apparatus for high speed dividing of articles on a production line, and in particular to a high speed apparatus for diverting same-size articles progressing along a conveyor device using a high velocity pusher device positioned proximal to the conveying device.

### BACKGROUND

Conventional dividers or diverters used in conveyor apparatus are used to divert articles from one conveyor line to another. Dairy product manufacturing facilities have a need to increase production. Present methods and apparatus cannot achieve the needed higher rates. Current dividers for handling same-size articles such as dairy cases are limited to handling about 45-52 articles per minute due to conveyor chain speed, case size and the need to maintain a large gap between articles. Due to these limitations it is currently necessary to reduce the maximum speed of a conveyor to avoid mishandling of the cases and backing up of cases along the conveyor in order to maintain the necessary large gap between cases as the cases are fed to the divider. All presently available divider apparatus must stop or retard product flow before the divider device can engage a case.

Therefore, currently, in order to improve throughput beyond about 50 cases per minute, it is necessary to provide multiple conveyor lines to share the load.

Thus it would be advantageous to provide an apparatus that would permit increased throughput of same-size articles on a conveyor line, preferably without slowing down the maximum speed of the conveyor line. It would be desirable to reduce or eliminate the presently required large gap between articles so that a conveyor line could operate at full speed without the need to stop or unduly retard the cases as they approach and engage the divider device. Such an improvement would be able to handle the extra load without the need to install multiple conveyor lines.

### SUMMARY OF THE INVENTION

The presently disclosed subject matter is directed to high speed apparatus and methods for diverting same-size articles such as dairy cases progressing along a conveyor device using a high velocity pusher device positioned proximal to the conveying device. The pusher device operates such that only a small gap between articles is necessary which increases article flow along the conveyor. The pusher device eliminates the need to stop or unduly retard the flow of articles along a conveyor line, permitting diverting of articles at full chain speed.

As used and described herein, the phrase “same-size” refers to articles having substantially the same dimensions, shape, mass and mass distribution. Dairy crates used in dairy operations may be considered “same-size” articles, as the dimensions, shape, mass and mass distribution of one crate to the next is typically uniform.

It is an object of the presently disclosed subject matter to provide an apparatus for diverting same size articles selectively to be either directed to a different conveying surface or to continue on the same conveying surface at a much greater rate than is currently achievable in the state-of-the-art.

It is a further object of the presently disclosed subject matter to provide an apparatus that may divert same size articles without stopping the main delivery line.

It is a further object of the presently disclosed subject matter to provide an apparatus for diverting same size articles from any low friction conveying surface onto another low friction conveying surface wherein the conveying surfaces may utilize belts, rollers, wheels, chains, slats or cables in a plurality of configurations tailored to a specific application.

In one embodiment the foregoing objectives are achieved by providing an apparatus for diverting same size articles using a high speed pusher which can be pneumatically, hydraulically, servo or a motor/cam/clutch driven to divert same size articles. In one embodiment the high speed pusher can be offset in either the upstream or downstream direction of article flow to optimize the entrance position to the exit of the articles being diverted. An angled pusher block may be employed to initiate the rotation of the article being diverted before the article enters an interchangeable exit to facilitate the flow of the diverted article. The pusher block may include a cushioned surface which contacts the articles to be diverted to prevent damage to the article being diverted due to the high acceleration required.

The pusher block may employ a pulse of power to drive the pusher block to obtain higher accelerations than what is considered normal in the industry. A short timer may be employed to control the pulse of power for increased acceleration instead of going from limit switch indication to limit switch indication, which is normal in the industry.

In operation, the high-speed pusher device imparts a high-velocity push on the article to be divided, preferably at a right angle to normal product flow. This push quickly removes the article from the product flow without the need to stop the main product flow, resulting in a significantly higher throughput.

In one embodiment an apparatus for selectively diverting same size articles conveyed along a conveyor line includes a pusher device positioned adjacent to a conveyor line and operable to push an article from the conveyor line to a path divergent from the path of the conveyor line, and a sensor positioned proximal to the pusher device and adjacent to the conveyor line, the sensor operable to detect the presence or absence of an article on the conveyor line. In one embodiment the sensor detects the presence of an article and actuates the pusher device to selectively push the article out of the conveyor line to a divergent path.

Yet another objective is to provide an apparatus for diverting same size articles using a frame with interchangeable exits to minimize parts and system layout design. A frame with interchangeable exits greatly simplifies the complexity of current state-of-the-art diverters which currently are made as a single unit that has a single exit direction that cannot be changed without replacement of the entire diverting unit. Using the interchangeable exits allows field change-over's to be done at minimal cost and effort. Moreover, interchangeable exits may be used without the need for powered or vertically declined pathways to enable the articles being conveyed in a different direction to be placed on the conveying surface where they will be utilized downstream of the diverter. Additionally, employing interchangeable exits without the need for powered or vertically declined pathways enables the articles being diverted to be at the same vertical height as the height from which they are being conveyed.

In one embodiment an apparatus for diverting same size articles is provided using a frame that can be mirror-imaged to allow right hand and left hand diverts by simply reassembling the frame before final assembly. Using the above capabilities of the mirrored frame and the interchangeable exits allows a minimum of ten (10) different directions for diverting.

In another embodiment an apparatus for selectively dividing same-size articles further includes a velocity control device to control the gapping required at the high diverting rates. The velocity control device may be employed to adjust the throughput of articles being conveyed to lower or higher values which would be dictated by the system design and requirements. For example, the velocity control device may be a velocity controlled wheel drive. A velocity controlled powered wheel drive may be used to introduce a gap that measures just a small fraction of an inch between the articles being diverted instead of the large gap required on some of the current state-of the-art diverters and/or instead of stopping the incoming flow of articles to allow a gap to form which would be required for current diverting operations. A velocity controlled wheel drive may be selectively commanded to operate at different velocities to control the articles when a lane downstream of the diverter gets full and the high throughput of the article being conveyed is no longer required at that time. In addition, a velocity controlled powered wheel drive may be employed which can be selectively commanded to increase the velocities of the articles being diverted when the system usage requires a higher through-put of the conveyed articles. Such a wheel drive may be employed which can be commanded to stop and retard the incoming articles when both lanes are full and the demand for the articles being conveyed is temporarily not required.

An apparatus for selectively dividing same-size articles may further include guide rails of tested critical dimensions and placements in the interchangeable exits to prevent jams and speed reductions of the article being diverted.

In one embodiment an apparatus for selectively diverting same-size materials includes materials and tested placements of components to allow the diverting of articles onto an adjacent parallel conveyor with a minimum of 24 inch centerlines.

In a preferred embodiment an apparatus is provided for diverting dairy cases having the same size to allow the diverting of articles onto an adjacent parallel conveyor.

### BRIEF DESCRIPTION OF THE DRAWING

For the purposes of illustration, there are forms shown in the drawings that are presently preferred, it being understood, however, that the invention is not limited to the precise arrangements and instrumentalities shown.

FIG. 1 is a perspective view of an embodiment of a diverter apparatus in accordance with an aspect of the present disclosure;

FIG. 1A is a rear perspective view of a diverter apparatus in accordance with an aspect of the present disclosure;

FIG. 1B is a front perspective view of the diverter apparatus of FIG. 1A in accordance with an aspect of the present disclosure;

FIG. 1C is a perspective view of the diverter apparatus of FIG. 1A in accordance with an aspect of the present disclosure;

FIG. 2A is a perspective view of an embodiment of a pusher device and sensing device of a diverter apparatus in accordance with an aspect of the present disclosure;

FIG. 2B is a side view of a pusher device of a diverter apparatus in accordance with an aspect of the present disclosure;

FIG. 2C is a top view of the pusher device of FIG. 2B in accordance with an aspect of the present disclosure;

FIG. 2D is a top view of a plate assembly in accordance with an aspect of the present disclosure;

FIG. 2E is a front view of a plate in accordance with an aspect of the present disclosure;

FIG. 2F depicts top, front and side views, respectively, from top to bottom, of plate 23b in accordance with an aspect of the present disclosure;

FIG. 2G depicts front and side views, respectively, left to right, of plate 23c in accordance with an aspect of the present disclosure;

FIG. 2H depicts front and side views, respectively, left to right, of a pad in accordance with an aspect of the present disclosure;

FIG. 2I is a front view of a plate in accordance with an aspect of the present disclosure;

FIG. 2J is a front view of a pad in accordance with an aspect of the present disclosure;

FIG. 3 is a top plan view of a diverter apparatus in accordance with an aspect of the present disclosure;

FIG. 4 depicts a perspective view of a frame in accordance with at least one embodiment of the disclosed subject matter;

FIGS. 4A-4J are top plan views of embodiments of a diverter apparatus showing options for different directions the diverter can send output, wherein the large arrows indicate the direction of feed flow and the small arrows indicate the direction of diverting, in accordance with aspects of the present disclosure;

FIG. 5 is a perspective view of an embodiment of a chute that may be employed in a diverter apparatus in accordance with an aspect of the present disclosure;

FIGS. 6A-F depict multiple top plan views of embodiments of a diverter apparatus showing modifications that can be made to the output section of the diverter in accordance with an aspect of the present disclosure; and

FIGS. 7 and 7A depict top plan views of examples of article handling apparatus set-ups employing a diverter apparatus in accordance with an aspect of the present disclosure.

### DETAILED DESCRIPTION OF THE PRESENT INVENTION

The following is a detailed description of the subject matter provided to aid those skilled in the art in practicing the present invention. Those of ordinary skill in the art may make modifications and variations in the embodiments described herein without departing from the spirit or scope of the present invention. Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. All publications, patent applications, patents, figures and other references mentioned herein are expressly incorporated by reference in their entirety.

In general, a high-speed diverting apparatus for selectively dividing or diverting same-size articles is provided permitting handling of more than eighty (80) same-size articles per minute when used in conjunction with a conveying feed line with a throughput of eighty articles per minute. The diverting apparatus is adaptable to provide modular and interchangeable exit directions for articles diverted from the conveying feed line.

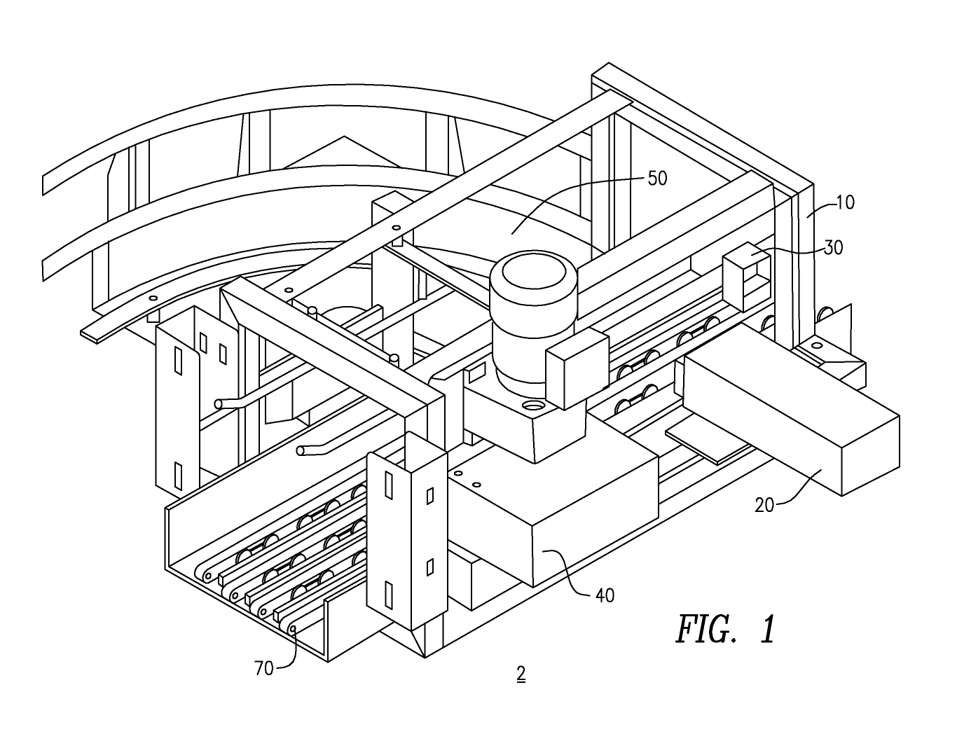

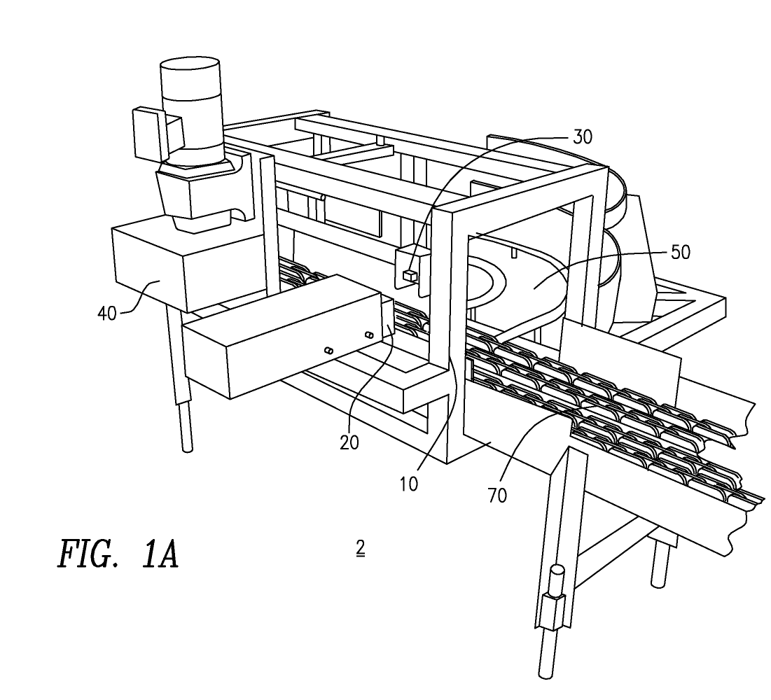

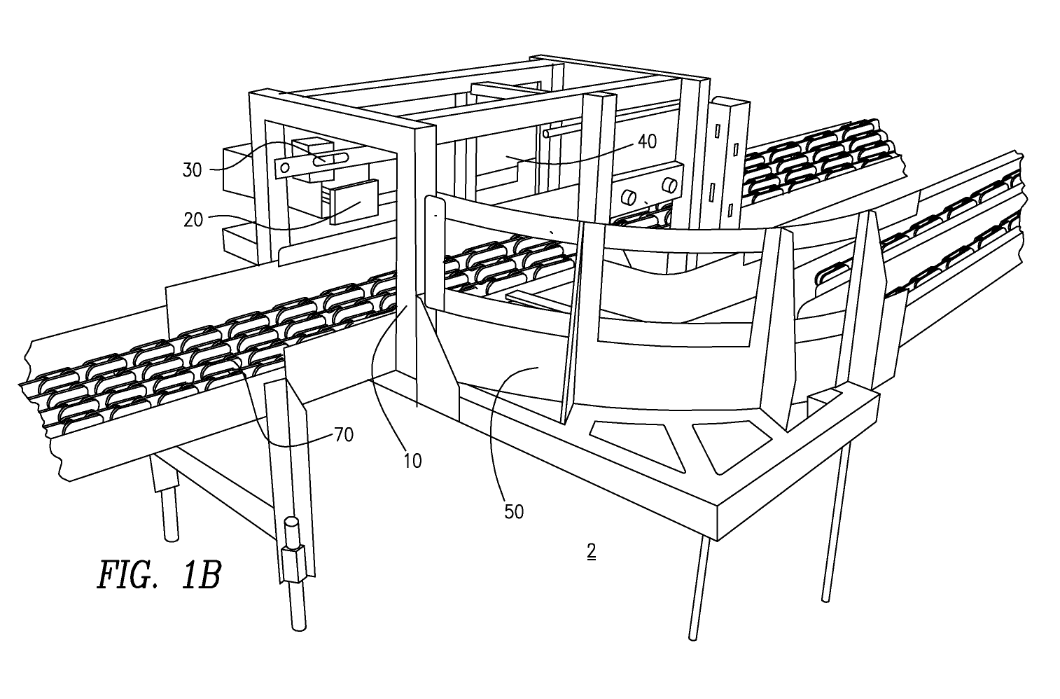

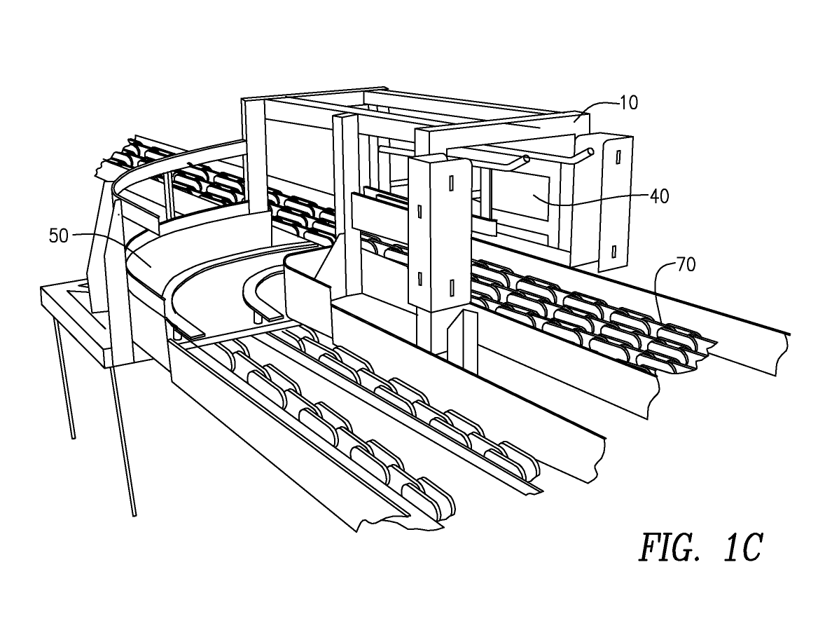

With reference to FIGS. 1-1C, a diverting apparatus 2 for use in conjunction with a conveying apparatus 70 in accordance with one aspect of the present invention includes a frame 10, a pusher device 20 mounted proximal the conveying apparatus 70, a sensor 30 mounted proximal the pusher device 20 and optionally a velocity control device 40. Pusher device 20 and sensor 30 are mounted to frame 10. If employed, velocity control device 40 is preferably mounted to frame 10. A chute 50 is disposed transverse to conveying apparatus 70 and opposite the pusher device 20.

Pusher device 20 may be any suitable device such as but not limited to a guided actuator. Suitable actuators such as guided actuators are commercially available for example from SMC Corporation of Noblesville, Ind. The pusher device may be tuned and customized to suitable specifications depending on the application. It will be apparent to the skilled artisan that the pusher device 20 may be hydraulically, pneumatically, servo or motor/cam/clutch driven. Preferably, pusher device 20 is pneumatic and is operable to operate off an 80 psi air hookup.

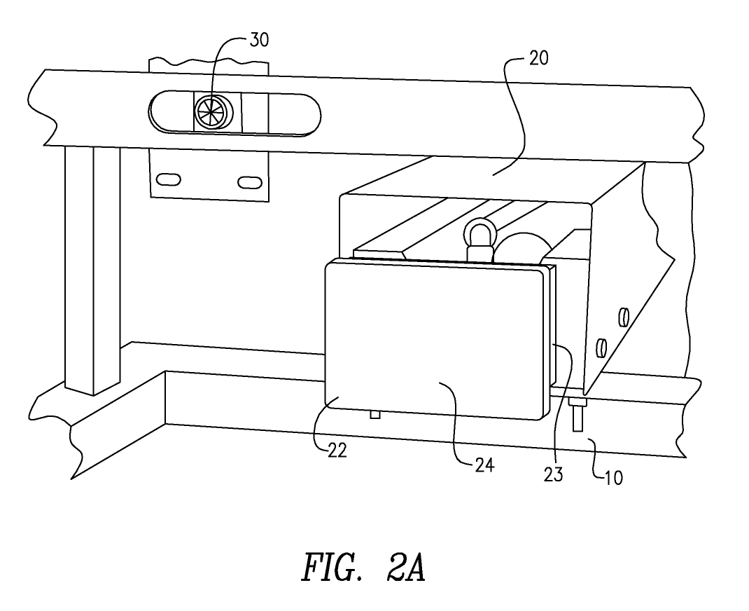

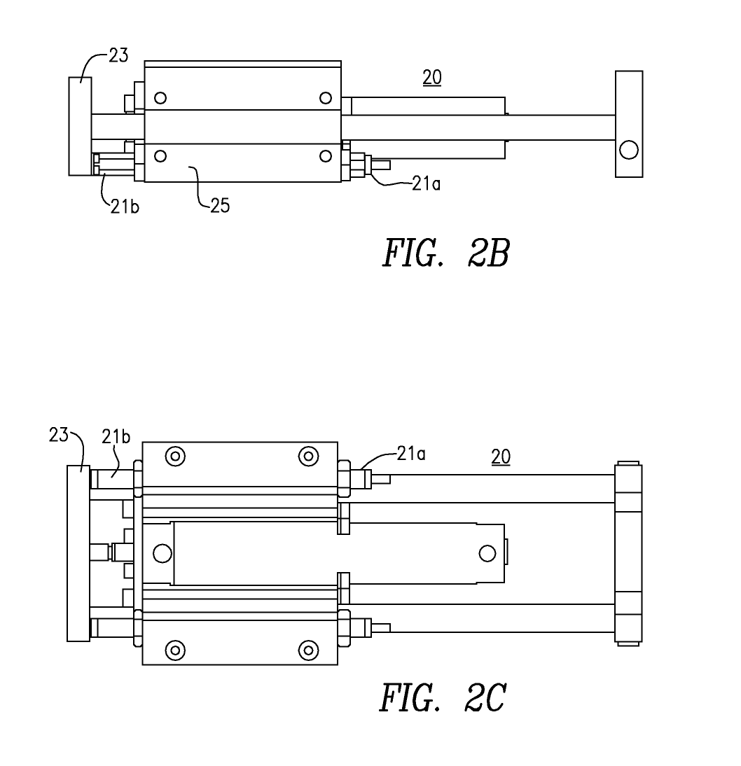

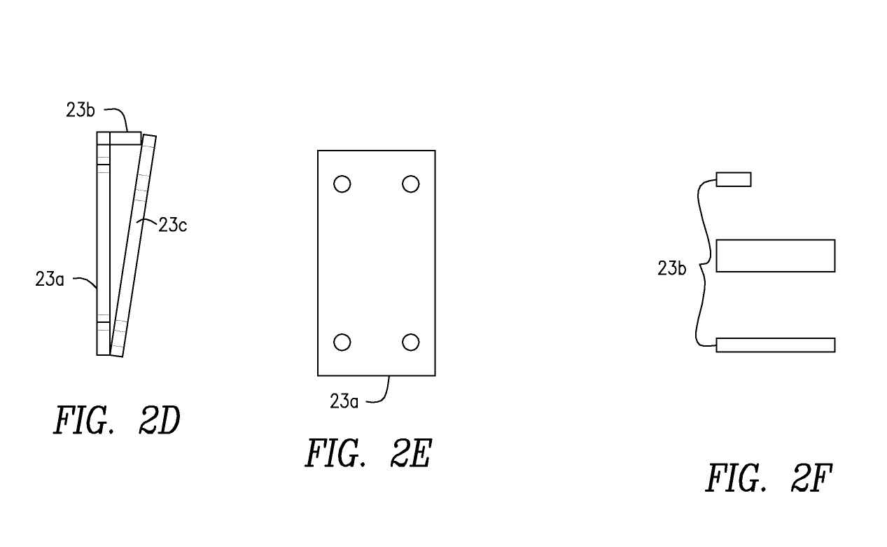

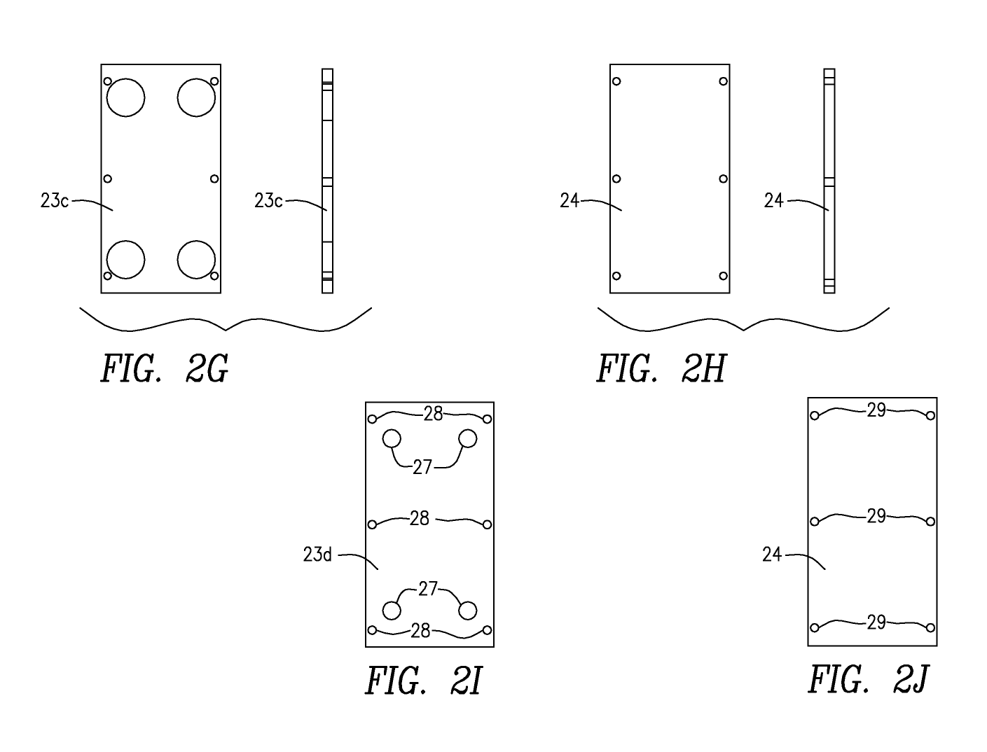

Now referring to FIG. 2A, in one embodiment the pusher device 20 includes a block 22 operable to contact the article to be pushed. The block 22 may include one or more plates 23 having a pad 24 of soft material such as fabric or a resilient material such as rubber, foam or the like mounted thereto to minimize damage to the article to be pushed.

Now referring to FIGS. 2B-2C, an exemplary pusher device 20 is depicted. Pusher 20 may be a stock guided cylinder commercially available for example from SMC Corp., and operable to be positioned in right, left and straight orientations. Now referring to FIGS. 2B-2H, details of an exemplary pusher device 20 are shown. Now referring to FIG. 2B, a side view of the pusher device 20 depicts an embodiment in which the pusher device 20 is a stock SMC guided cylinder. Plate 23 is operable to receive a pad (not shown) that contacts and pushes against the article being diverted. Shock absorbers 21a and 21b, one for each direction of travel, are located on diametrically opposite corners of the main guided cylinder body 25. Shock absorber 21a is built into the unit to retard the end of stroke impacts. Shock absorber 21a as shown is in the uncompressed state. Shock absorber 21b which is shown touching the plate 23 is in the compressed state.

Now referring to FIG. 2C, a top view of pusher device 20 depicts a stock SMC guided cylinder. Shock absorber 21a as shown is in the uncompressed state. Shock absorber 21b which is shown touching the plate 23 is in the compressed state.

Now referring to FIG. 2D, in one embodiment a top view of block 22 depicts plates 23a, 23b and 23c welded together and operable to receive a pad (not shown) such as for example a rough top belt padding. With further reference to FIG. 2E, base plate 23a is operable to be fastened by suitable fastening means to a guided cylinder mounting plate 23 depicted in FIGS. 2B-2C. Fastening means may include bolts, screws, adhesives and the like. With further reference to FIG. 2F, standoff plate or brace 23b is a horizontal plate positioned and operable to hold plates 23a and 23c at the required angle and typically is welded in place due to frequent impacts. Referring further to FIG. 2G and 2H, the angled plate 23c is the plate for receiving a pad 24. Plate 23c has openings formed therein that allow clearance for a socket wrench to install fasteners such as bolts thru the vertical plate 23a to the guided cylinder mounting plate 23. Additional openings may be formed for receiving fasteners for attaching a pad 24. Pad 24 is shown having openings formed therein for fastening to the angled plate 23c. In this embodiment the material employed for the pad 24 is a rough belt material. One skilled in the art will recognize the foregoing embodiments are merely exemplary. For example, a greater or lesser number of openings may be employed; and fastening means other than bolts, screws or the like may be employed such as adhesive, welds, or the like.

Plates 23a-23c may be any suitable thickness. On one embodiment the thickness of one or more of the plates 23a-23c is about 0.25 inches. The plates may have a length of about 4 to about 5 inches, preferably about 4.5 inches. Plate 23c is preferably longer than plate 23a, depending on the desired angle between the two plates. Plates 23a and 23c have a width of about 2 to about 3 inches. Plate 23b has a width of about 0.4 to about 1.0 inch, preferably between about 0.62 and 0.64 inches and most preferably about 0.634 inches.

FIGS. 2I-J depict a plate 23d and pad 24 formed of rough belt material that may be used in an application requiring a straight push perpendicular to the direction of travel of the main conveyor line. As shown in FIG. 2I, plate 23d includes openings 27 that are formed therein which permit fastening with bolts, screws or the like to plate 23 and openings 28 for fastening a pad 24 thereto. Pad 24 includes openings 29 for receiving fasteners to attach pad to plate 23d. Other fastening means may be employed, such as adhesive, rendering openings 27, 28 and 29 unnecessary.

Plate 23d may also be adjustably mounted so that it may form an appropriate impact angle with respect to the article to be pushed. For example, the plate 23d may be angled at 15 degrees with respect to the conveying apparatus to impart a rotational push to start the article on its required rotating path relative to the conveying device 70 to push the article toward a chute 50 oriented at a 45 degree angle relative to the conveying apparatus 70. Alternatively, plate 23d may be substituted with plates having varying degrees of angulation not exceeding an angle that would cause the increased diametrical length to close the small gap between articles with respect to the conveyor flow.

Referring again to FIGS. 1A, 1B and 2A, sensor 30 is mounted proximal to pusher device 20 to detect the presence of an article, and depending on programming, as described in further detail hereinbelow, may actuate the pusher device 20 to push the article detected from the conveying apparatus toward chute 50. As will be apparent to those skilled in the art, sensor 30 may be a light sensor, ultrasonic sensor or an electromechanical switch. It is believed a light sensor or ultrasonic sensor is preferable to an electromechanical switch, which may be prone to mechanical breakdown through repetitive use. In an embodiment employing a light sensor 30, sensor 30 may be programmed for example as follows:

dark operate, off when object present;

light operate, off when object present;

light operate, off when blocked; and

On when pusher is sensed.

Sensor 30 may be any suitable commercially available sensor such as 42EF-B1MPBC available from Allen-Bradley of Milwaukee, Wis., USA.

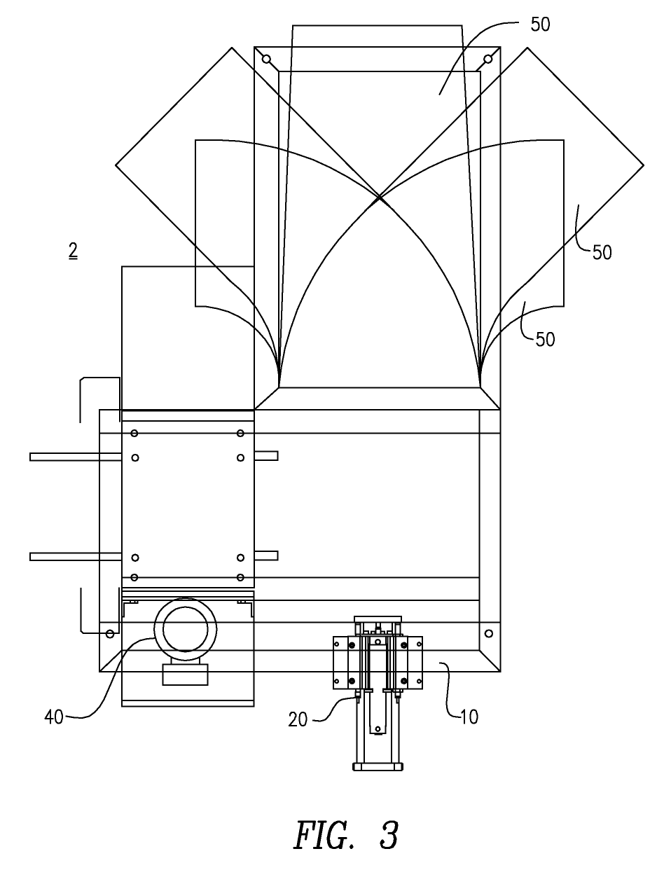

Now with further reference to FIG. 3, velocity control device 40 may be a wheel drive. Velocity control device 40 may be employed in applications where it is necessary to slightly retard the article flow along conveying device 70. As shown, velocity control device 40 is positioned proximal to conveying apparatus 70 to contact articles situated on the conveyor apparatus before they reach the pusher device 20 and/or sensor 30. The slight retardation of the article permits a gap between articles as they reach the pusher device, thus avoiding a situation wherein the articles might interfere with the pushing operation. A considerable advantage is achieved by the use of a velocity control device 40 in that it may operate to introduce a gap that measures just a small fraction of an inch between the articles being diverted instead of the large gap required on some of the current state-of the-art diverters and/or instead of stopping the incoming flow of articles to allow a gap to form which would be required for current diverting operations. In another embodiment, the conveying device 70 may be slowed and the velocity control device 40 may be used to speed up the article to advance the article to the pushing stage.

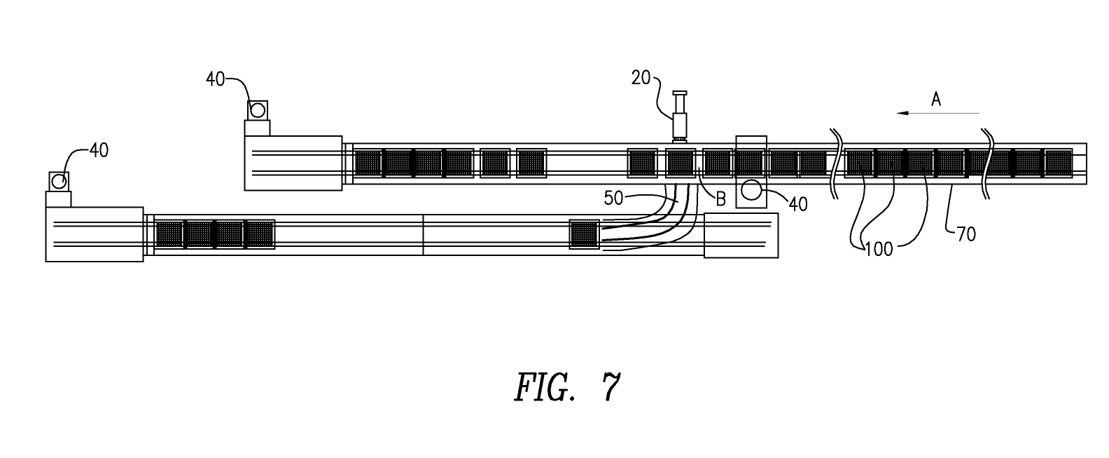

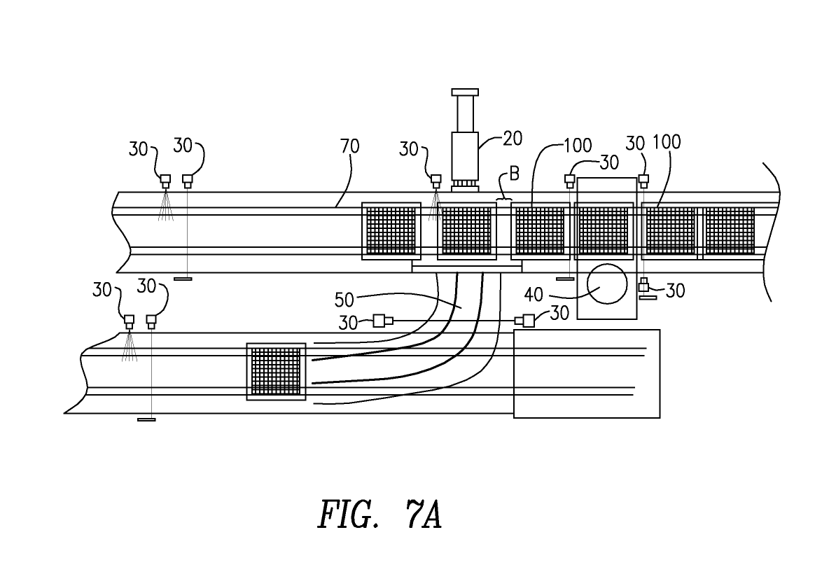

A velocity control device 40 may be selectively commanded to operate at different velocities to control the articles when a lane downstream of the diverter gets full and the high throughput of the article being conveyed is no longer required at that time. In addition, a velocity control device 40 may be employed which can be selectively commanded to increase the velocities of the articles being diverted when the system usage requires a higher through-put of the conveyed articles. Velocity control device 40 may be employed which can be commanded to stop and retard incoming articles when both lanes are full and the demand for the articles being conveyed is temporarily not required. Plural velocity control devices 40 may be employed to control article flow along various conveyor sections of an article handling apparatus, as further depicted in FIG. 7A.

In a preferred embodiment the velocity control device is a custom motor-driven wheel drive having a variable frequency drive. Velocity control device 40 which includes a variable frequency drive may use any suitable commercially available variable frequency drive such as 22A-V2P3N104 available from Allen-Bradley of Milwaukee, Wis., USA. Wheel drives may have any suitable horsepower ranging from about 0.3 to about 5 horsepower and operate at from about 20 to about 100 rpm. Depending on the sprocket employed, an inverter may be employed at about 40 to about 100 Hz. In one embodiment velocity control device 40 adjacent pusher 20 operates at about 20-31 rpm when the linear speed of the main feed line is 80 feet/minute.

In another embodiment, not shown, an additional brake device may be employed before the wheel drive to retard the flow of articles further. This brake may be employed in circumstances when all destinations for articles are full, such that the backup of articles would result in a force sufficient to overcome the braking ability of the velocity control device 40.

It will be apparent to those skilled in the art that it is not always necessary to employ any velocity control device. For example, articles along a conveyor in certain applications may have sufficient spacing between them to obviate the need for a velocity control device. In one example, articles that have been selectively diverted to a chute will often have a large gap between them, so subsequent pushing devices employed for further diverting will not require braking prior to entering a subsequent pushing stage.

FIG. 3 also depicts various angles that may be employed for chute 50.

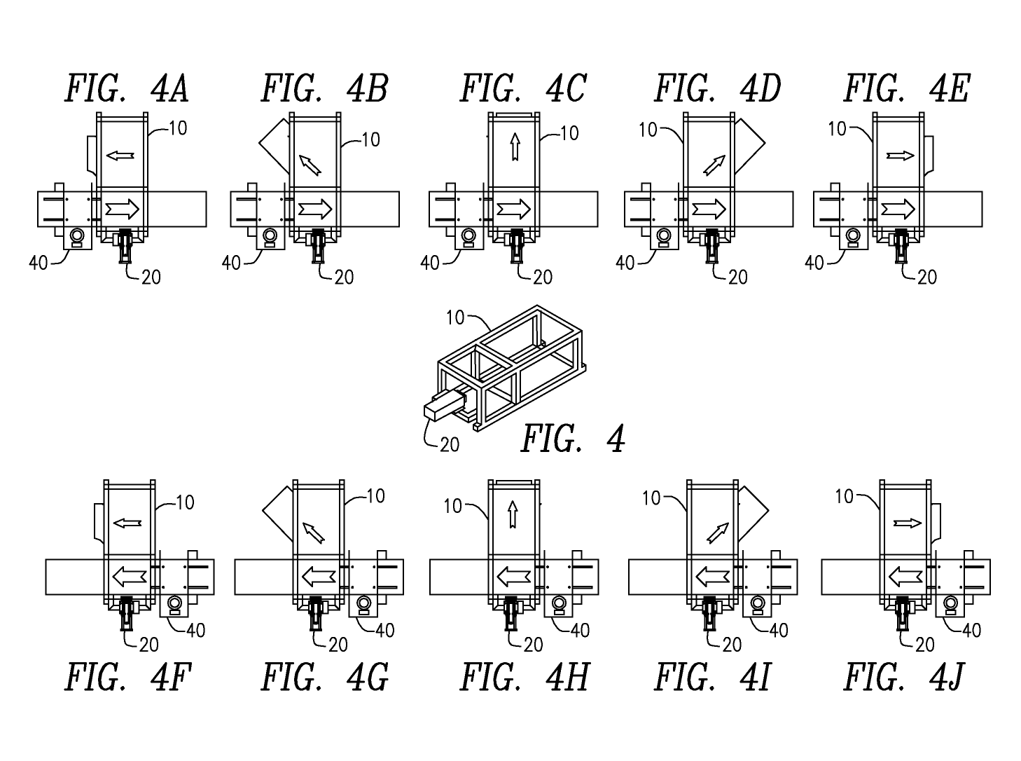

Now referring to FIG. 4, a frame 10 in accordance with at least one embodiment of the disclosed subject matter is disclosed. Frame 10 may be any suitable design for accommodating the passage therethrough, or thereby, of articles being conveyed. As will be apparent to the skilled artisan, the frame structure and design may be adapted depending on the particular application. Preferably, frame is designed to accommodate the mounting thereto of a pusher device 20, a sensor 30 and velocity control device 40 as shown in FIG. 1. However, it will be apparent that any or all of pusher device 20, sensor 30 and velocity control device 40 may be mounted to a structure separate from frame 10.

FIGS. 4A-4F further depict multiple embodiments of a diverter apparatus showing options for different directions the diverter can send output. The arrows in each of the FIGs. indicate the direction of article flow, the large arrow indicating main line flow and the smaller arrow indicating diverted flow. As shown in these examples, flow can be diverted in essentially any direction from the main flow, between 90 degrees left of the main line flow and 90 degrees right of the main line flow, regardless of whether main line flow is proceeding from left to right or right to left.

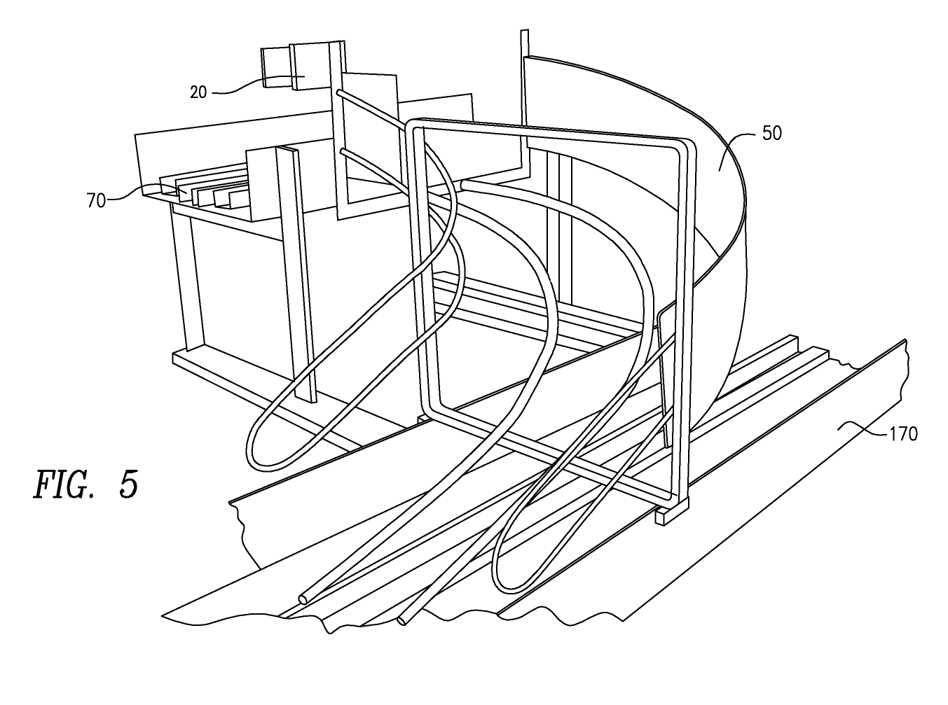

Now referring to FIG. 5, an example of an embodiment of a chute 50 is shown that may be employed in a diverter apparatus where it is desired to divert articles from the main line flow on a conveyor line 70 to a lower conveyor line 170.

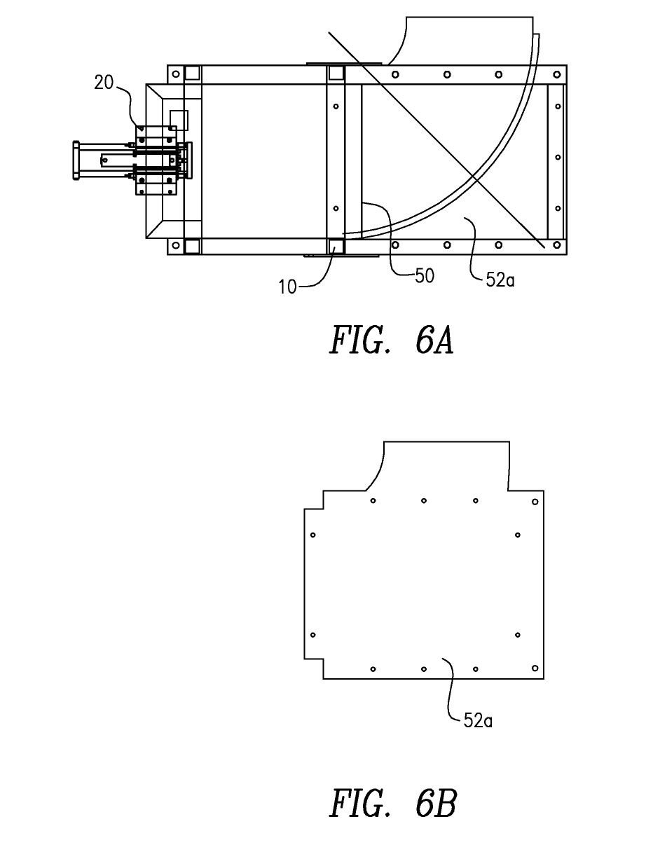

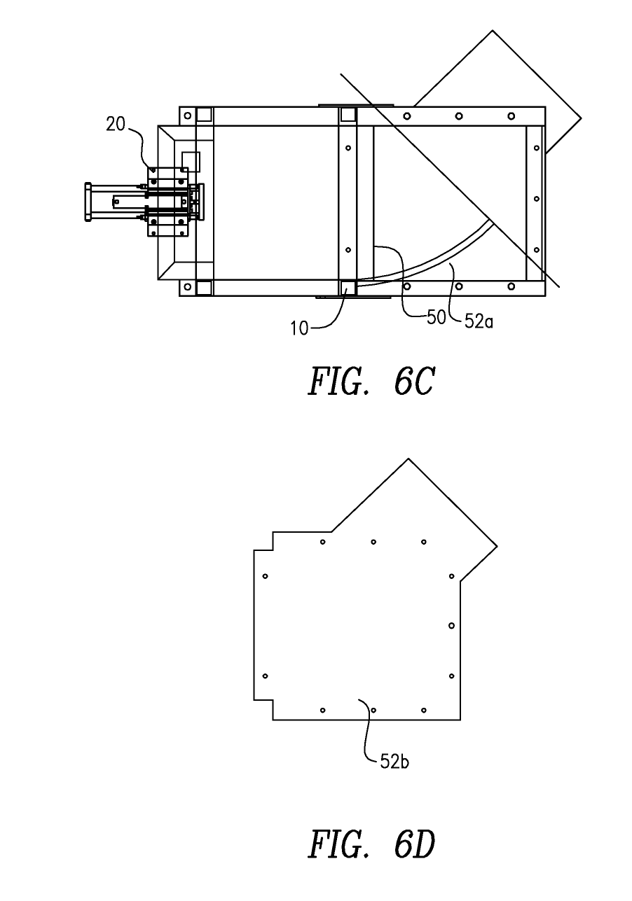

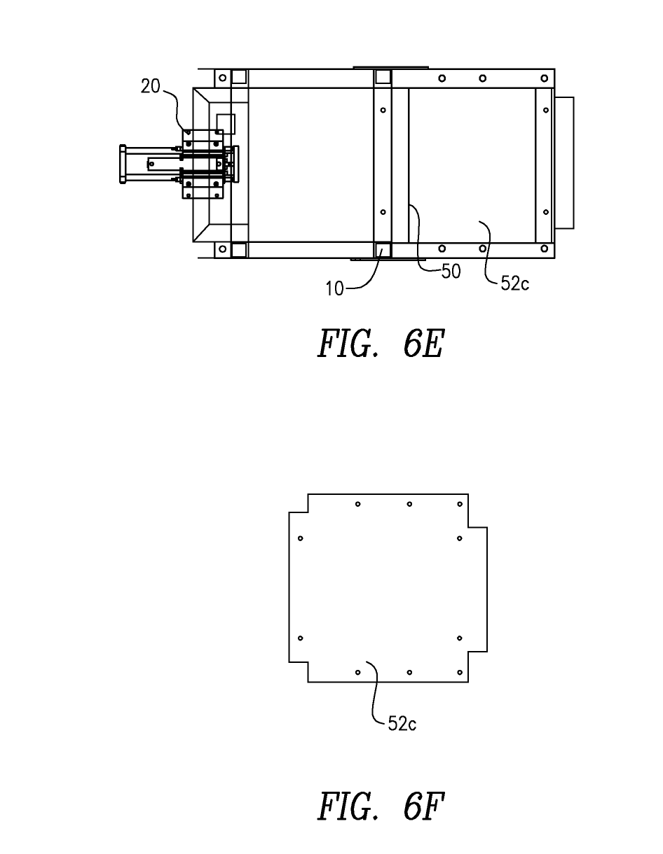

Now referring to FIGS. 6A-F, multiple top plan views of embodiments of a diverter apparatus are shown depicting interchangeable parts that can be used to modify the output section of the diverter apparatus 2. In particular, various plates are depicted which are operable to be removably attached to a frame 10 and form a base of a chute 50. FIG. 6A shows a diverter apparatus with a chute turned to exit 90 degrees from the pusher device 20, employing the base plate 52a shown in FIG. 6B. FIG. 6C shows a diverter apparatus with a chute turned to exit 45 degrees from the pusher device 20, employing the base plate 52b shown in FIG. 6D. FIG. 6E shows a diverter apparatus with a chute turned to straight from the pusher device 20, employing the base plate 52c shown in FIG. 6F. Using a frame with interchangeable exits minimizes parts and system layout design. A frame 10 which is operable to have interchangeable plates 52a, 52b, 52c mounted thereto to provide interchangeable chutes 50 or exits greatly simplifies the complexity of current state-of-the-art diverters which currently are made as a single unit that has a single exit direction that cannot be changed without replacement of the entire diverting unit. Using the interchangeable exits as described and shown herein allows field change-over's to be done at minimal cost and effort. Moreover, interchangeable exits may be used without the need for powered or vertically declined pathways to enable the articles being conveyed in a different direction to be placed on the conveying surface where they will be utilized downstream of the diverter. Additionally, employing interchangeable exits without the need for powered or vertically declined pathways enables the articles being diverted to be at the same vertical height as the height from which they are being conveyed.

Now referring to FIGS. 7 and 7A, embodiments of article handling apparatus set-ups employing a diverter apparatus in accordance with the present disclosure are provided. With reference to FIG. 7, articles 100 process along conveying apparatus 70 in the direction of arrow A. The articles are advanced to a staging area located between the pusher device and entrance to the chute 50. Before an article 100 reaches the staging area, the article 100 may be contacted by a velocity control device 40, which may retard the article 100 just enough to introduce a gap B between the article 100 and the article 100 ahead of it. Thus, a gap B may be introduced between each of the articles 100 just before they reach the staging area. With further reference to FIG. 7A, when a leading edge of an article 100 is detected by sensor 30, the pusher device 20 either actuates to impact the article 100, thereby driving the article to exit the conveyor 70 and enter the chute 50; or does not actuate, permitting the article 100 to pass through the staging area and continue on the conveyor 70. Whether an article 100 is to be diverted to another path is programmed into a control module such as a Programmable Logic Controller (PLC) control module commercially available from Allen-Bradley Industrial Controls of Milwaukee, Wis. The speed of the velocity control device may also be programmed into the control module. Because of the gap between successive articles and the high velocity impact of the pusher device 20, no article interferes with the article being diverted or the pusher device 20 during the diverting action.

Further sensors 30 may be employed along conveyor 70 to maintain an appropriate gap between undiverted articles 100 moving past the pusher 20, and to maintain an appropriate gap between diverted articles exiting the chute 50. The setting for appropriate gaps is also programmable into the control module linked to the sensors 30, pusher 20 and velocity control device 40.

As described hereinabove, an article handling apparatus including a diverter for selectively dividing same-size articles may further include guide rails of tested critical dimensions, materials and placements in the interchangeable exits to prevent jams and speed reductions of the article being diverted.

In a preferred embodiment an apparatus for selectively diverting same-size materials includes an apparatus as described herein for diverting of articles onto one or more adjacent parallel conveyor(s), on the same or different vertical level as the main line conveyor. In a most preferred embodiment, a material handling system is provided which includes an apparatus as described herein for diverting of articles, such as for diverting dairy cases having the same size, to allow the diverting of articles onto an adjacent parallel conveyor. Apparatus in accordance with the foregoing embodiments are capable of handling and diverting in excess of eighty (80) dairy cases per minute.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

What is claimed is:

1. An apparatus for selectively diverting same size articles comprising a conveying apparatus, a pusher device positioned proximal the conveying apparatus, at least one divergent pathway disposed transverse to the conveying apparatus and substantially opposite the pusher device, and at least one sensor positioned proximal the pusher device, wherein the sensor is operable to detect the presence or absence of an article on the conveyor apparatus and actuate the pusher device to selectively push the article to the divergent pathway.

2. The apparatus according to claim 1 further comprising a frame operable to accommodate the passage therethrough, or thereby, of articles being conveyed.

3. The apparatus according to claim 2 wherein the frame comprises an aperture through which diverted articles may pass.

4. The apparatus according to claim 3 comprising at least one interchangeable plate removably mountable to the frame, the at least one plate operable to form at least a portion of a chute.

5. The apparatus according to claim 1 further comprising a velocity control device operable to control gap distance between articles, the velocity control device positioned adjacent the conveying apparatus and upstream of the pusher device relative to an article feed direction.

6. The apparatus according to claim 5 wherein the velocity control device is operable to adjust the throughput of articles being conveyed.

7. The apparatus according to claim 5 wherein the velocity control device comprises a velocity controlled wheel drive.

8. The apparatus according to claim 5 comprising more than one velocity control device.

9. The apparatus according to claim 1 comprising a control module programmable to control operation of at least the pusher device.

10. The apparatus according to claim 5 comprising a control module programmable to control operation of at least the pusher device and the velocity control device.

11. The apparatus according to claim 1 wherein the pusher device comprises a pusher block positioned to divert same-size articles in a specified direction.

12. The apparatus according to claim 1 wherein the pusher device is operable to divert articles in either an upstream or downstream direction of article flow to optimize entrance position of the article to the chute.

13. The apparatus according to claim 1 wherein the pusher device comprises an angled pusher block operable to initiate rotation of an article being diverted before the article enters the chute.

14. The apparatus according to claim 1 wherein the pusher device comprises a block comprising a cushioned surface positioned to contacts articles to be diverted.

15. The apparatus according to claim 11 wherein the pusher device is operable to impart a high-velocity push on the article to be divided at a right angle to article flow along the conveyor device.

16. The apparatus according to claim 1 comprising a further conveyor device substantially parallel to a first conveyor device adjacent the pusher device, the further conveyor device operably connected to the first conveyor device by the chute.

17. The apparatus according to claim one operable to divert dairy cases having the same size.

18. The apparatus according to claim 1 operable to process at least eighty same-size articles per minute when used in conjunction with a conveying feed line with a throughput of eighty articles per minute.

19. The apparatus according to claim 1 wherein the sensor is operable to detect a leading edge of an article conveyed on the conveyor device and deliver a signal to the pusher device to impact the article, thereby driving the article to exit the conveyor and enter the chute, or to not actuate, permitting the article to pass and continue on the conveyor device.

20. A frame operable to be used in an apparatus for selectively diverting same size articles, the apparatus comprising a conveying apparatus, the frame comprising a pusher device mounted thereon and positioned proximal the conveying apparatus, and at least one sensor mounted on the frame positioned proximal the pusher device, the frame comprising a first opening to accommodate the passage therethrough, or thereby, of articles being conveyed along conveyor apparatus, the frame further comprising a second opening through which diverted articles may pass, the second opening positioned adjacent the pusher device and operable to be adjoining at least one divergent pathway disposed transverse to the conveying apparatus and substantially opposite the pusher device, wherein the sensor is operable to detect the presence or absence of an article on the conveyor apparatus and actuate the pusher device to selectively push the article to the divergent pathway, the frame further comprising at least one interchangeable plate removably mountable to the frame, the at least one plate operable to form at least a portion of a chute.
